(19) United States
(12) Patent Application Publication
(10) Pub. No.: US 2025/0025816 A1
(43) Pub. Date: Jan. 23, 2025

(54) SEPARATOR APPARATUS ROTOR

(71) Applicant: Edwards Limited, Burgess Hill, Sussex (GB)

(72) Inventors: Mark Richard O'Neill, Clevedon Somerset (GB); Ian David Stones, Burgess Hill, Sussex (GB); Ian David Benzeval, Clevedon Somerset (GB); Fraser Gray, Clevedon Somerset (GB)

(21) Appl. No.: 18/712,554

(22) PCT Filed: Nov. 22, 2022
(86) PCT No.: PCT/GB2022/052956

§ 371 Date: May 22, 2024

(30) Foreign Application Priority Data
Nov. 23, 2021 (GB) 2116828.1

(51) Int. Cl. B01D 45/14

(52) U.S. Cl. CPC B01D 45/14

(57) ABSTRACT

The present invention relates to a rotor for a separator apparatus. The rotor having an axis of rotation and comprising an inlet operable to receive an effluent stream, an annular skirt defining a centrifugal separator operable to separate the effluent stream, the centrifugal separator having a gas outlet in first direction and a waste outlet in a second direction. A surface of the annular skirt is angled towards the axis of rotation of the rotor, such that during rotation of the rotor, non-gaseous matter in the effluent stream is biased towards the waste outlet by contact with said surface. The invention also relates to a separator apparatus comprising such a rotor, a method of treating an effluent stream, and a method of designing a rotor.

### CROSS-REFERENCE OF RELATED APPLICATION

This application is a Section 371 National Stage Application of International Application No. PCT/GB2022/052956, filed Nov. 22, 2022, and published as WO 2023/094804 A1 on Jun. 1, 2023, the content of which is hereby incorporated by reference in its entirety and which claims priority of British Application No. 2116828.1, filed Nov. 23, 2021.

### FIELD

The present invention relates to a rotor for a separator apparatus, a separator apparatus, a method of treating an effluent stream, and a method of designing a rotor for a separator apparatus.

### BACKGROUND

Separator apparatus are known. Such apparatus are used for treatment of an effluent stream containing particles in a fluid.

Although separator apparatus of the prior art provide treatment of the effluent stream, there is an ongoing need for improved separator apparatus. Particularly, there is a desire to improve the efficiency of separation of the gaseous matter and the non-gaseous matter of the effluent stream. Non-gaseous matter of the effluent stream may comprise particles, which must be separated from the gaseous matter by the separator apparatus. The particles may be produced by process apparatus to which the separator apparatus is connected. The particles may be, for example, silica and/or metal oxides. Preferably, the separator apparatus may separate the gaseous matter from the particles, such that the gaseous matter is ejected through a gas outlet and the particles through a waste outlet. It is desirable to minimise particles exiting the separator through the gas outlet.

The effluent stream may also comprise a liquid, for example water, which must be separated from the gaseous matter by the separator apparatus. Desirably, the liquid may be directed through the waste outlet, mixed with the particles. In separator apparatus of the prior art, it has been found by the inventors that water is often ejected via the gas outlet, exiting through the exhaust of the separator apparatus, which is undesirable.

Furthermore, it has been discovered by the inventors that liquid ejected from the gas outlet may become trapped between a rotor and a stator of the separator apparatus. This may cause drag on the rotation of the rotor. Additional drag is detrimental to the operation of the separator apparatus, as it may increase the power required to rotate the rotor at its operational RPM.

Separator apparatus of the prior art typically are large and have a large footprint, which is undesirable.

The present invention aims to solve, at least in part, these and other problems associated with separator apparatus of the prior art.

The discussion above is merely provided for general background information and is not intended to be used as an aid in determining the scope of the claimed subject matter. The claimed subject matter is not limited to implementations that solve any or all disadvantages noted in the background.

### SUMMARY

In an aspect, the present invention provides a rotor for a separator apparatus. The rotor has an axis of rotation. The rotor comprises an inlet operable to receive an effluent stream. The rotor also comprises an annular skirt defining a centrifugal separator operable to separate the effluent stream, the centrifugal separator having a gas outlet in a first direction and a waste outlet in a second direction. A surface of the annular skirt is angled towards the axis of rotation of the rotor, such that during rotation of the rotor, non-gaseous matter in the effluent stream is biased towards the waste outlet by contact with said surface.

During operation of a separator apparatus comprising a rotor according to the present invention, the rotor may be configured to rotate relative to a stator. The rotor may be arranged on a rotor shaft during use. The rotor shaft may provide the rotational drive to the rotor to cause it to rotate. During operation, the rotor may rotate at a rate of, for example, 30 to 75 Hertz.

The axis of rotation of the rotor may be the axis about which, during operation, the rotor is configured to rotate. Preferably, when viewed along the axis of rotation, the axis of rotation may pass through a centroid of the rotor. Typically, the axis of rotation may be substantially vertical during use. Preferably, when mounted upon a rotor shaft of a separator apparatus during use, the axis of rotation may be coaxial with a central axis and axis of rotation of the rotor shaft.

The inlet may be fluidly coupled to outlet of a process apparatus to which the separator apparatus is connected during operation. The process apparatus may be, for example, a subsystem within an abatement system that treats a process stream, such as a mixture of silane in nitrogen. Typically, the separator apparatus may be connected immediately downstream of the energetic section of the abatement system, for example a gas fired combustor. The effluent stream may be an outlet flow from the process apparatus.

The inlet may be configured to convey the effluent stream to the centrifugal separator. The effluent stream may comprise gaseous and non-gaseous matter. The separator apparatus may be configured to separate the gaseous matter from the non-gaseous matter of the effluent stream. The gaseous matter may comprise, for example, a mixture of combustion products, process diluent nitrogen and potential acid gas products. The non-gaseous matter may comprise particulate matter. The non-gaseous matter may additionally comprise water, and/or other liquids.

Preferably, the annular skirt may have a central axis coaxial with axis of rotation of the rotor. The annular skirt may be arranged radially outwardly of the inlet. For the purposes of the present invention, references to radial directions and positions are made in relation to the axis of rotation of the rotor. During operation, the effluent stream may be transmitted to the annular skirt by, at least in part, centrifugal force.

The centrifugal separator may be arranged to separate at least some of the gaseous and non-gaseous matter of the effluent stream. Preferably, the centrifugal separator may be configured to ensure that at least 80%, preferably at least 95%, of the non-gaseous matter of the effluent stream exits the centrifugal separator via the waste exit.

The gas outlet may be configured, when in use, to convey matter in a first direction, preferably wherein the first direction is generally parallel to or angled towards the axis of rotation of the rotor. The waste outlet may be configured, when in use, to convey matter in second direction, preferably wherein the second direction is different to the first direction. More preferably, the second direction is substantially opposite the first direction. In a preferred example when the rotor is arranged within the separator apparatus and in operation, the first direction may be generally vertically upwards and the second direction may be generally vertically downward. For the purposes of the present invention, generally vertical may be within about 20°, preferably within about 10°, preferably within about 5° of vertical. Advantageously, this may allow that during operation the waste outlet, centrifugal separation of the effluent stream may be gravitationally assisted as the denser non-gaseous matter is biased towards the waste outlet. The less dense gaseous material may exit through the gas outlet.

Typically, when in use, the gas outlet may be generally vertically aligned. Preferably, when in use, the waste outlet may be generally vertically aligned.

The surface is angled towards the axis of rotation of the rotor. As the rotor rotates during use, a centrifugal force may be imparted on the non-gaseous matter to bias it in the second direction. The formula for calculating the centrifugal force on a particle during rotation is:

$$F = \frac{{mv}^{2}}{r}$$

Where m=particle mass (kg), v=tangential velocity (ms⁻¹), r=radius of rotation (m). Accordingly, as the centripetal force has an inverse relationship with the radius, the non-gaseous matter in contact with the surface is biased towards the part of the surface with the larger radius, i.e. in the second direction.

Preferably, the surface may be angled towards the axis of rotation of the rotor such that, a first portion of the surface may have a smaller radial distance from the axis of rotation of the rotor than that of a second portion of the surface. Thus, a biasing centrifugal force may be imparted on the non-gaseous matter in contact with the surface to convey it towards the portion of the surface having a larger radial distance from the axis of rotation of the rotor.

Advantageously, the rotor according to the present invention may provide improved separation of the effluent stream as non-gaseous matter is biased towards the waste outlet by the angled surface. This may allow clean, dry gas, (i.e. substantially free from non-gaseous matter), to flow from the gas outlet. Furthermore, instances of non-gaseous matter exiting the rotor via the gas outlet may be reduced.

Typically, the gas outlet may comprise one or more conduits extending within the annular skirt. The conduits may extend generally in the first direction. A wall defining a conduit may provide the surface. Preferably, at least a portion of the wall defining at least one conduit may be angled towards the axis of rotation of the rotor. Preferably, the wall defining each conduit may provide the surface.

There may be from about one to about 300 conduits, for example 120 conduits. The number of conduits may be selected according to the specific effluent stream treatment requirements of the device in question. The conduits may be spaced generally evenly about the annular skirt. Preferably, the conduits may be evenly spaced about the annular skirt.

During rotation of the rotor, the wall of the conduit providing the surface may be configured to entrain the non-gaseous matter and separate it from the gaseous matter as the effluent stream is conveyed therethrough. The non-gaseous matter may impact the surface and experience a centrifugal biasing force towards the waste outlet. Each conduit may comprise a conduit inlet for receiving the effluent stream and a conduit outlet, which may be the gas outlet. The conduit inlet may be fluidly connected to the waste outlet.

Advantageously, the wall(s) defining the conduit(s) providing the surface may improve separation of the non-gaseous matter and gaseous matter of the effluent stream.

Additionally, or alternatively, a generally radially inward facing wall of the annular skirt may provide the surface. Advantageously, in use, rotation of the rotor may produce a centrifugal bias on non-gaseous matter in contact with said surface. This may bias the non-gaseous matter to drain towards the waste outlet.

Additionally, or alternatively, a generally radially outward facing wall of the annular skirt may provide the surface. In use, the generally radially outward facing wall may be adjacent a stator of the separator apparatus, with a clearance therebetween.

In separator apparatus of the prior art, the generally radially outward facing wall of the rotor and a generally radially inward facing wall of the stator are parallel. The rotor and stator would have typically been arranged such that non-gaseous matter could pass through the clearance and flow towards a sump. However, non-gaseous matter passing through the clearance contacting both the rotor and the stator could provide unwanted resistance against rotation of the rotor. Particularly, liquid between the rotor and stator could increase friction and resist against rotation of the rotor.

In embodiments of the present invention, a generally radially outward facing wall of the annular skirt may provide the surface and be angled towards the axis of rotation of the rotor. This may provide a bias for non-gaseous matter to be forced towards the portion of the surface having a larger radial distance from the axis of rotation, and therefore towards the sump of the separator apparatus.

Advantageously, such embodiments may bias non-gaseous matter that has exited the waste outlet and migrated to be in contact with the generally radially outward facing wall of the annular skirt towards the portion of the surface having a larger radial distance from the axis of rotation, and therefrom towards a sump of the separator apparatus. This may reduce the likelihood of said non-gaseous matter dwelling on the surface and/or migrating away from the sump of the separator apparatus.

For the avoidance of doubt, in a preferred embodiment, at least a portion of the wall(s) defining at least one conduit, and a generally radially inward facing wall of the annular skirt, and a generally radially outward facing wall of the annular skirt each provide the surface(s). Such an embodiment may provide all of the benefits recited hereinbefore.

Preferably, the generally radially outward facing wall of the annular skirt and the generally radially inward facing wall of the stator may not be parallel. Instead, there may be an acute angle between the respective surfaces. This may reduce the likelihood of non-gaseous matter contacting both the rotor and the stator simultaneously. Advantageously, this may reduce friction between the rotor and stator during use, which may reduce the power requirements to run a separator apparatus comprising a rotor according to the present invention.

Preferably, the wall(s) defining the conduit(s), the generally radially inward facing wall of the annular skirt, and the generally radially outward facing wall of the annular skirt may be angled towards the axis of rotation of the rotor.

Typically, at least a portion of the surface angled towards the axis of rotation is at an angle of from about 0.1° to about 45°, preferably from about 1° to about 20°, more preferably from about 5° to about 15°, for example 10°, to the axis of rotation.

Typically, the rotor may comprise a generally cylindrical chamber defined by a base plate and an opposing roof plate, coupled by the annular skirt. Preferably, the annular skirt may couple the base plate and opposing roof plate about their respective radially outermost points.

The distance between the base plate and opposing roof plate may be less than, preferably significantly less than, the diameter of the plates, which may advantageously provide for a particularly compact arrangement. For example, the ratio of the diameter of the plates to the distance between the plates may be at least 3:1, preferably at least 5:1, more preferably at least 10:1. Preferably, the base plate and opposing roof plate may be substantially parallel.

The conduit(s) may be fluidly connected to the generally cylindrical chamber. The conduit(s) may provide the gas outlet. In use, the effluent stream may be conveyed through the generally cylindrical chamber to the annular skirt. The annular skirt may define a radially outermost wall of the generally cylindrical chamber.

The inlet may be centrally located in the base plate or the opposing roof plate, preferably in the opposing roof plate. Centrally located may mean that the inlet is aligned with the axis of rotation of the rotor. Providing the inlet centrally within the base plate or opposing roof plate helps to maximise the centrifugal separation of the effluent stream, as the effluent stream is conveyed radially outwardly between the inlet and the gas and waste outlets. Furthermore, this arrangement may avoid the need for complex feeds into the separator apparatus. The inlet may be connected to an outlet of processing apparatus, from which the effluent stream may flow.

The waste outlet may be located in the base plate or opposing plate, preferably in the base plate. The waste outlet may be operable to drain non-gaseous matter from the rotor into a sump of the centrifugal separator. Typically, the waste outlet may comprise one or more holes in the base plate and/or annular rim. Preferably, the waste outlet may comprise at least 2, 4, 6, 8, or 10 or more holes in the base plate and/or annular rim.

Typically, the rotor may comprise one or more radially extending vanes operable to convey the effluent stream from the inlet to the centrifugal separator. Preferably the vane(s) may extend from the inlet towards the annular skirt. Preferably, there may be from about 2 to about 12 vanes, for example 6 vanes. The height and/or width of the vane(s) may taper towards the annular skirt. Advantageously, such tapering of the vanes towards the annular skirt may reduce the turbulent flow of the effluent stream in the vicinity of the annular skirt when in use, which may aid the separation of the gaseous and non-gaseous matter.

The vane(s) may be directly connected to the base plate and/or opposing plate, preferably the base plate. More preferably, the vane(s) may be integrally formed with the base plate and/or opposing plate, as a single monolithic component.

The vane(s) may terminate prior to the annular skirt to define a volume within which the effluent stream accelerated by the vanes is received prior to separation. Hence, the effluent stream may be received within a volume defined by the ends of the vanes and the annular skirt. The vane(s) may additionally aid in the separation of the gaseous and non-gaseous matter of the effluent stream, as the non-gaseous matter may be retained on the surface of a vanes and directed therefrom to the waste outlet.

The one or more holes defining the waste outlet may be arranged proximate at least one of the annular skirt and/or the end of a vane. Advantageously, this may aid the draining of the non-gaseous matter from the rotor.

Typically, a wall defining a conduit may provide the surface and the conduit further comprises a first portion with walls that are substantially parallel to the axis of rotation of the rotor. Preferably, the portion of the wall defining the conduit that provides the surface is at or adjacent the gas outlet.

Typically, the annular skirt may extend beyond the opposing roof plate in the first direction. The generally radially inward facing surface of the annular skirt may extend beyond the opposing roof plate in the first direction. Advantageously, the opposing roof plate and annular skirt may provide a lip in which non-gaseous matter that has exited the rotor via the gas outlet may be collected. Typically, the opposing roof plate may comprise one or more holes whereby such non-gaseous matter may pass through the opposing roof plate and into the generally cylindrical chamber, following which it may exit through the waste outlet. Preferably, the number and/or position of the holes may align with that of the waste holes. Preferably, the annular skirt may extend beyond the opposing roof plate in the first direction by at least the distance between the base plate and the opposing roof plate.

Typically, the gas outlet and waste outlet are configured, when in use, to convey matter in substantially opposite directions.

Typically, when in use, the waste outlet may be arranged such that it is generally vertically aligned, and/or arranged below the gas outlet when the rotor is positioned within the separator apparatus. Advantageously, this may improve the separation of gaseous and non-gaseous matter from the effluent stream. In such configurations, gravity may aid in the separation of the gaseous and non-gaseous matter from the effluent stream.

Preferably, the waste outlet comprises a plurality of ports within the annular skirt or base plate. The waste outlet may comprise from about 1 to about 50 ports within the annular skirt or base plate, preferably from about 2 to about 20 ports, more preferably from about 2 to about 10 ports. The ports may be generally evenly spaced about the annular skirt or base plate. Preferably, the plurality of ports may be spaced about the annular skirt or base plate in a circular arrangement.

During operation, the components of the rotor may remain substantially stationary relative to each other. The rotor may comprise a single, unitary component. Alternatively, the rotor may comprise a two-or-more-piece arrangement, wherein the pieces are connected such that the components of the rotor remain substantially stationary relative to each other during use. Advantageously, the entire rotor may rotate as a unitary component during operation. This may simplify the overall design of the separator apparatus, having fewer components in relative motion. Additionally, this may reduce the tolerance stack of the rotor, which may allow for tighter clearances between components.

Typically, the inlet may comprise a weir operable to introduce liquid, for example water, into said effluent stream. The weir may be adjacent the inlet to the rotor, and may surround and mix the liquid with the effluent stream entering the rotor. Advantageously, the presence of water within the effluent stream may facilitate the separation of gaseous and non-gaseous matter of the effluent stream. The water may capture particles for separation by the centrifugal separator. Preferably, the non-gaseous matter as defined hereinbefore may comprise a mixture of water and particles.

In a further aspect, the present invention provides a separator apparatus comprising a rotor according to any embodiment of the preceding aspect.

Typically, the separator apparatus may further comprise a stator defining a chamber that substantially surrounds the rotor. Preferably, the stator may define a generally cylindrical chamber substantially surrounding the rotor.

Typically, the separator apparatus may further comprise a rotor shaft on which the rotor is arranged and configured to rotate relative to the stator. The separator apparatus may further comprise a drive mechanism, coupled to the rotor shaft and configured to rotate the rotor shaft and the rotor during operation. The drive mechanism may comprise a motor.

Typically, the separator apparatus may further comprise a sump configured to collect non-gaseous matter from the waste port and/or from a clearance between the rotor and the stator. Preferably, the sump may be arranged below the waste outlet during operation of the separator apparatus. Preferably, the radial clearance between the rotor and stator may allow non-gaseous matter to pass through, but be small enough to substantially prevent backflow of non-gaseous matter from the sump to a region above the rotor.

Typically, the separator apparatus may further comprise an outlet port in the chamber configured to vent gas from the gas outlet. Preferably, the outlet port may be arranged above the rotor during operation of the separator apparatus. Advantageously, such an arrangement may reduce instances of non-gaseous matter exiting via the outlet port.

Preferably, the separator apparatus may comprise a liquid recirculation system operable to convey liquid from the sump to mix with the effluent stream. The liquid recirculation system apparatus may be configured to provide liquid to the weir. Preferably, liquid (e.g. water) in the sump may be recirculated by the liquid recirculation system back to the weir. Advantageously, this may reduce waste liquid by the system.

Preferably, the drive mechanism may also provide the drive for the liquid recirculation system. Beneficially, this may allow the rotation of the rotor and circulation of water to be powered by a single drive mechanism, e.g. a single motor. This may reduce the complexity and power requirements of the separator apparatus.

In a further aspect, the present invention provides a method of treating an effluent stream. The method comprises the steps of:
a) providing a rotor according to any of preceding aspect or embodiment, or a separator apparatus according to any preceding aspect or embodiment;
b) rotating the rotor;
c) directing an effluent stream comprising gas and particles through the inlet of the rotor;
d) conveying the effluent stream through the centrifugal separator such that at least some particles contact the surface and are biased towards the waste outlet; and
e) venting gas through the gas outlet and directing at least some of the particles through the waste outlet.

Advantageously, the method according to the present invention may provide improved separation of the effluent stream, as non-gaseous matter (i.e. particles) may be biased towards the waste outlet. Furthermore, the rotation of the rotor may provide some pumping of the effluent stream. This may ease the transition between the pressure of the pumping and/or abatement apparatus, and the atmosphere.

The method may further comprise the step of mixing water with the effluent stream, prior to its conveyance through the centrifugal separator. Such mixing may occur by the introduction of water to the effluent stream by a weir as described hereinbefore. Advantageously, the presence of water within the effluent stream may facilitate the separation and capture of particles within the water by the centrifugal separator.

The method may further comprise the step of recirculating water that has exited the rotor via the waste outlet. Advantageously, this may reduce water use by the apparatus. For the purpose of the invention, water includes any aqueous fluid, although water is preferred, particularly mains water.

In a further aspect, the present invention provides a method of designing a rotor according to any preceding aspect or embodiment. The method comprises the steps of determining:
a. the angle and arrangement of the surface, and/or
b. the number of gas outlets, and/or
c. the number of waste outlets, and/or
d. the rotation speed of the rotor during operation, and/or
e. the number and arrangement of the vanes, and/or
f. the aspect ratio of the gas outlets,
required to separate at least some particles from the gas of the effluent stream.

The requirements for separation of gaseous and non-gaseous matter of an effluent stream may depend on the composition of the effluent stream. This multifactorial approach to designing a rotor may enable the rotor to provide improved separation of gaseous and non-gaseous matter from the effluent stream.

In a preferred embodiment, the angle of the surface may be from about 0.1° to about 20°, for example 10°.

In a preferred embodiment, the number of gas outlets may be from about 80 to about 150, for example 120.

In a preferred embodiment, the number of waste outlets may be from about 3 to about 12, for example 6.

In a preferred embodiment, the rotation speed of the rotor during operation may be from about 30 Hz to about 75 Hz, for example 50 Hz.

In a preferred embodiment, there may be from about 1 to about 10 vanes, for example 6 vanes.

In a preferred embodiment, the aspect ratio of the gas outlets may be from about 5:1 to about 15:1, for example 10:1.

For the avoidance of doubt, all aspects and embodiments described hereinbefore may be combined mutatis mutandis.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Preferred features of the present invention will now be described, by way of example, with reference to the accompanying drawings, in which:

FIG. 1 illustrates a cross-sectional view of a rotor in accordance with an embodiment of the present invention.

FIG. 2 illustrates a schematic of the centrifugal separation of an effluent stream by a rotor in accordance with an embodiment of the present invention.

FIG. 3A illustrates a cross-sectional view of a portion of a rotor.

FIG. 3B illustrates a cross-sectional view of a portion of a rotor in accordance with an embodiment of the present invention.

FIG. 3C illustrates a cross-sectional view of a portion of a rotor in accordance with an embodiment of the present invention.

FIG. 4 illustrates an embodiment of a base plate of a rotor in accordance with an embodiment of the present invention.

FIG. 5 illustrates an embodiment of a separator apparatus in accordance with an embodiment of the present invention.

FIG. 6 illustrates a flow diagram of a method of treating an effluent stream in accordance with an embodiment of the present invention.

### DETAILED DESCRIPTION

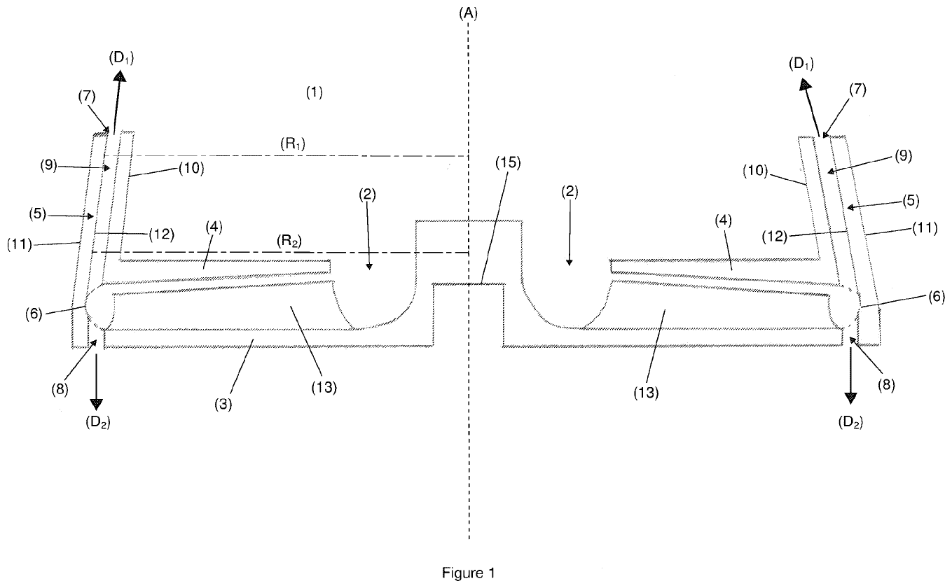

FIG. 1 shows a cross-sectional view of a rotor (1) in accordance with an embodiment of the present invention. The rotor (1) has an axis of rotation (A). When in use, the axis of rotation (A) is typically generally vertically aligned.

The rotor (1) comprises an inlet (2) operable to receive an effluent stream. The rotor (1) further comprises a generally cylindrical chamber defined by a base plate (3), an opposing roof plate (4), and an annular skirt (5). The annular skirt (5) couples the respective radially outermost portions of the base plate (3) and opposing roof plate (4). The base plate (3) and opposing roof plate (4) are generally parallel.

The annular skirt (5) defines a centrifugal separator (6) having a gas outlet (7) in a first direction (D₁), and a waste outlet (8) in a second direction (D₂). The gas outlet (7) is defined by a plurality of conduits (9) extending within the annular skirt (5). The dashed lines indicate the intersection between the centrifugal separator (6) and the conduits (9) and waste outlets (8), respectively.

The annular skirt (5) has a generally radially inwardly facing surface (10) and a generally radially outwardly facing surface (11).

A surface (12) defining the conduit (9) is angled towards the axis of rotation (A) of the rotor (1), such that during rotation of the rotor (1), non-gaseous matter in the effluent stream is biased in a second direction (D₂) towards the waste outlet (8) by contact with said surface (12). As the rotor (1) rotates during operation, centrifugal forces acting on the non-gaseous matter bias said matter towards the region of the surface furthest from the axis of rotation (A), i.e. the region with the larger radial distance from the axis of rotation. As shown in FIG. 1, the surface (12) defining the conduit (9) is angled towards the axis of rotation (A) of the rotor (1) such that there is a region having a radial distance (R₁) from the axis of rotation (A) that is smaller than the radial distance (R₂) from the axis of rotation (A) of a second region.

In use, non-gaseous matter is biased towards the region having the larger radial distance (R₂) from the axis of rotation (A). This region is proximal to the waste outlet (8) and distal from the gas outlet (7). Therefore, non-gaseous matter is biased towards the waste outlet (7) and away from the gas outlet (7). Gaseous matter may exit in a first direction (D₁) via the gas outlet (7).

Typically, when in use, the first direction (D₁) is generally vertically aligned. Preferably, the first direction (D₁) is generally upwards. Typically, when in use, the second direction (D₂) is generally vertically aligned. Preferably, the second direction (D₂) is generally downwards.

The generally radially inward facing surface (10) is angled towards the axis of rotation (A) of the rotor (1). During rotation of the rotor (1), non-gaseous matter in the effluent stream is biased towards ports (not shown) in the opposing roof plate (4). The ports are positioned at the intersection between the generally radially inwardly facing surface (10) and the opposing roof plate (4). The ports are configured to allow non-gaseous matter in contact with the generally inwardly radially facing surface (10) and/or the opposing roof plate (4) to pass through the opposing roof plate (4), whereby it may exit the rotor (1) via the waste outlet (8). This may advantageously allow for removal of non-gaseous matter that has unintentionally escaped via the gas outlet (7).

During rotation of the rotor (1), non-gaseous matter (e.g. water and particles) in contact with the generally radially inwardly facing surface (10) are biased by centrifugal forces towards a region of the surface furthest from the axis of rotation (A). Thus, the non-gaseous matter is biased towards the ports in the opposing roof plate (4) and thereby directed towards the waste outlet (8).

The generally radially outward facing surface (11) of the annular skirt (5) is angled towards the axis of rotation (A) of the rotor (1). During rotation of the rotor (1), non-gaseous matter in the effluent stream is biased in a second direction (D₂) towards a sump (not shown). Non-gaseous matter, e.g. water and/or particles, in contact with the generally radially outwardly facing surface (11) is biased towards a region of the surface (11) furthest from the axis of rotation (A). Therefore, the non-gaseous matter is biased towards the sump.

The surface (12) defining the conduit (9), the generally radially inwardly facing surface (12), and the generally radially outwardly facing surface (11) are angled towards the axis of rotation (A) at an angle of from about 1° to about 20°, preferably about 10°.

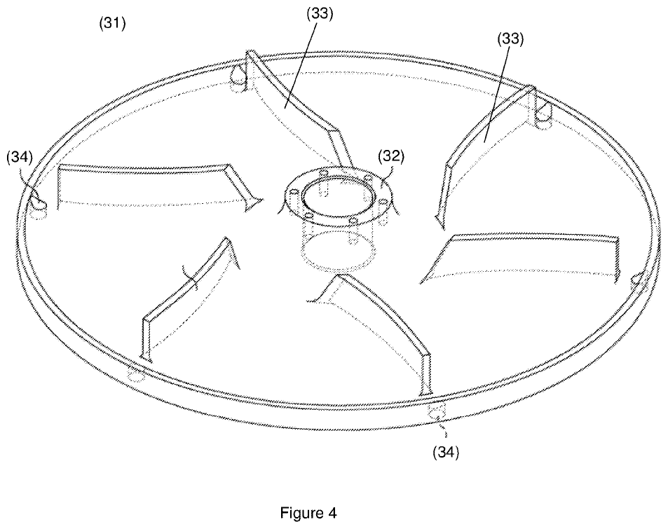

The rotor (1) comprises a plurality of radially extending vanes (13). The vanes (13) are operable to convey the effluent stream from the inlet (2) to the centrifugal separator (6). The vanes (13) are directly connected to the base plate (3). The vanes (13) may extend radially outwardly, or may be curved to define a spiral pattern, as can be seen in FIG. 4.

The rotor (1) further comprises a mounting portion (15), whereby the rotor (1) is affixed to a rotor shaft (not shown) of the separator apparatus during use.

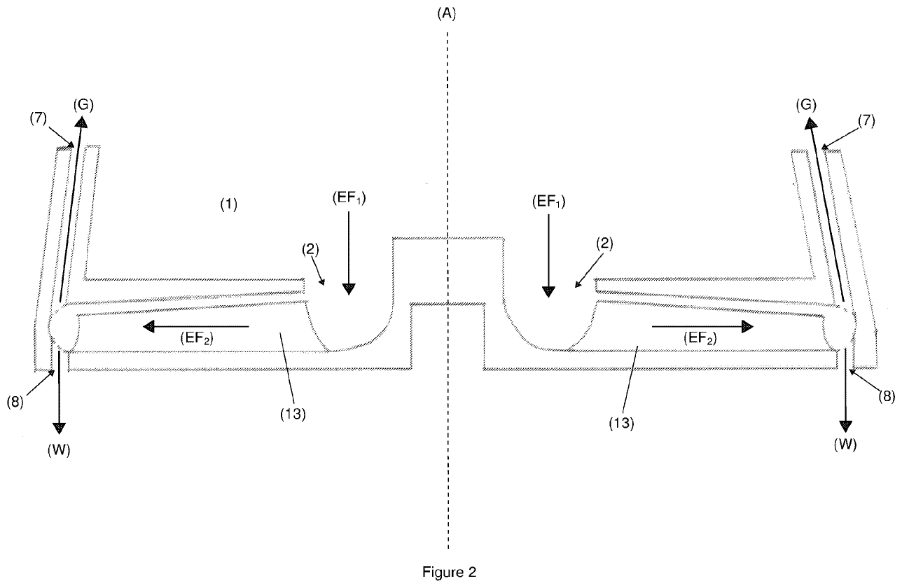

FIG. 2 shows a schematic of the centrifugal separation of an effluent stream by a rotor (1) in accordance with an embodiment of the present invention. The rotor (1) is the same as that shown in FIG. 1, accordingly the same reference numerals will be used and the features will not be re-stated.

During operation, the rotor (1) continuously rotates about the axis of rotation (A). An effluent stream comprising gas, particles, and preferably liquid (e.g. water), is directed through an inlet (2) of the rotor (1). This is shown by arrows (EF₁).

Next, the effluent stream is conveyed through the generally cylindrical chamber of the rotor (1) by the vanes (13). This is shown by arrows (EF₂).

Next, the effluent stream is separated such that the gaseous matter is vented through the gas outlet (7), as shown by arrow (G). Non-gaseous matter (i.e. water and particles) is drained via the waste outlet (8), as shown by arrow (W).

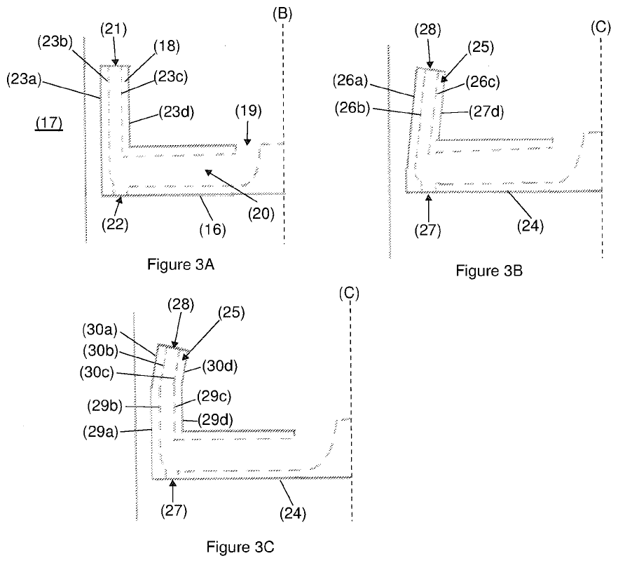

FIG. 3A shows a cross-sectional view of a portion of a rotor (16), not falling within the scope of the present invention. The rotor (16) is arranged adjacent a stator (17). The surface of the stator (17) is parallel to the axis of rotation (B) of the rotor (16). The rotor (16) comprises an annular skirt (18). The dashed lines indicate the inlet (19), generally cylindrical chamber (20), gas outlet (21), and waste outlet (22).

It can be seen that the surfaces (23a, 23b, 23c, 23d) defining the annular skirt (18) and gas outlet (21), are each parallel to the axis of rotation (B) and the surface of the stator (17). When the rotor (16) is rotating about the axis of rotation (B), the surfaces (23a, 23b, 23c, 23d) provide little to no centrifugal biasing force on non-gaseous matter in contact therewith. Therefore, the non-gaseous matter may exit via the waste outlet (22), or, unwantedly, via the gas outlet (21).

Furthermore, the radially outward facing surface (23a) is parallel to the surface of the stator (17). Thus, along the entire length of the surface (23a), the clearance between it and the stator (17) remains the same. This increases the likelihood of particles and/or water getting stuck therebetween and increasing the friction against the rotation of the rotor (16).

FIG. 3B shows a cross-sectional view of a portion of a rotor (24) according to an embodiment of the present invention. In this embodiment, the annular skirt (25) of the rotor (24) is angled towards the axis of rotation (C) of the rotor (24). Additionally, the annular skirt (25) of the rotor (24) is angled away from the surface of the stator.

The surfaces (26a, 26b, 26c, 26d) defining the annular skirt (25) are each angled towards the axis of rotation (C) of the rotor (24). Accordingly, in use, when the rotor (24) is rotating about the axis of rotation (C), non-gaseous matter in contact with any of the surfaces (26a, 26b, 26c, 26d) experiences a centrifugal force that biases the matter towards the waste outlet (27) and away from the gas outlet. Advantageously, this may reduce the likelihood of non-gaseous matter exiting the rotor (24) via the gas outlet (28).

Along the majority of its axial length, the radially outward facing surface (26a) is not parallel to the surface of the stator. This may reduce the likelihood of particles and/or water getting stuck therebetween, and increasing the friction against the rotation of the rotor (24).

FIG. 3C shows a cross-sectional view of a portion of a rotor (24) according to an alternative embodiment of the present invention. Many of the features are the same as those described in FIG. 3B, so the same referencing will be used.

The annular skirt (25) of the rotor (24) comprises a first portion wherein the surfaces (29a, 29b, 29c, 29d) are parallel to the axis of rotation (C) of the rotor (24). Additionally, the annular skirt (25) comprises a second portion wherein the surfaces (30a, 30b, 30c, 30d) are angled towards the axis of rotation (C) of the rotor (24). Accordingly, in use, when the rotor (24) is rotating about the axis of rotation (C), non-gaseous matter in contact with the surfaces (30a, 30b, 30c, 30d) experiences a centrifugal force that biases the matter towards the waste outlet (27) and away from the gas outlet (28). This may provide the same advantages as the arrangement of FIG. 3B.

FIG. 4 shows an embodiment of a base plate (31) forming part of a rotor in accordance with the present invention.

The base plate (31) comprises a central hub (32). The base plate (31), and thereby the rotor, are connected to a rotor shaft of the separator apparatus via said central hub (32).

The base plate (31) further comprises a plurality of radially extending vanes (33) coupled thereto. The skilled person will appreciate that the vanes may, additionally or alternatively, be coupled to an opposing roof plate (not shown) of the rotor. In this embodiment, the vanes (33) are directly connected to the base plate (31) as a single, unitary component. The vanes (33) extend from the base plate (31) in a generally axial direction. The vanes (33) are curved in a radially outward direction. The vanes (33) are configured to, in use, convey and/or accelerate the effluent stream from an inlet of the rotor to the centrifugal separator. This action may additionally provide some separation of the effluent stream.

The base plate (31) further comprises the waste outlet (34), in the form of a plurality of holes in the base plate (31). The waste outlet(s) (34) are arranged proximal to the radially outermost end of the vanes (33). Thereby, non-gaseous matter conveyed by the vanes (33) can exit the rotor via the waste outlet(s) (34).

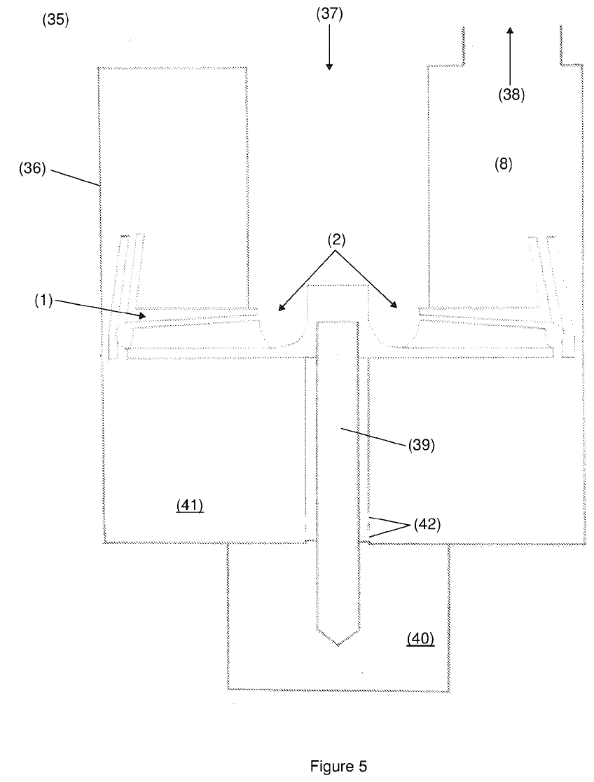

FIG. 5 shows a cross-sectional view of a separator apparatus (35) in accordance with an embodiment of the present invention.

The separator apparatus (35) comprises a rotor (1) according to the embodiment described in FIG. 1. The separator apparatus (35) further comprises a stator (36) defining a generally cylindrical chamber that substantially surrounds the rotor (1). An inlet (37) is provided in the stator (36) through which, in use, an effluent stream enters the separator apparatus (35). A wall of the inlet (37) defines or is connected to a weir, whereby liquid (e.g. water) is mixed with the incoming effluent stream. The inlet (37) is fluidly coupled to an inlet (2) of the rotor (1).

The stator (36) further comprises a gas outlet (38), through which gaseous matter separated from the effluent stream may be vented to the atmosphere. Typically, the gas outlet (38) is arranged above the rotor (1) when the separator apparatus is in operation.

The rotor (1) is connected to and configured to rotate with a rotor shaft (39), relative to the stator (36). The rotor shaft (39) is located centrally within the chamber defined by the stator (36). The separator apparatus (35) further comprises a drive mechanism (40), coupled to the rotor shaft (39) and configured to rotate the rotor shaft (39) and rotor (1) during operation. Preferably, during operation of the separator apparatus (35), the rotor shaft (39) are generally vertically aligned. The drive mechanism (40) comprises a motor. The drive mechanism (40) is arranged externally of the chamber defined by the stator (36).

The stator (36) comprises a sump (41). The rotor (1) is positioned within the chamber defined by the stator (36) such that the sump (41) is on the opposite side of the rotor (1) to the gas outlet (38). During operation of the separator apparatus, the sump (41) is arranged below the rotor (1), such that matter exiting via the waste outlet (8) can drain into the sump (41).

Preferably, the rotor shaft (39) and/or stator (36) comprise one or more channels (42). The channels (42) are positioned towards the bottom of the sump (41). The channels (42) are fluidly connected to a liquid recirculation system (not shown) and the weir. The channels (42) allow water to be recirculated from the sump (41) to the weir during operation, reducing the amount of water required to operate the separator apparatus (35). Preferably, the liquid recirculation system is driven by the drive mechanism (40), simplifying the apparatus.

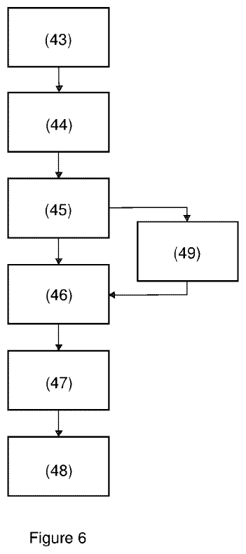

FIG. 6 shows a flow diagram of a method of treating an effluent stream in accordance with an embodiment of the present invention.

The method comprises the steps of:
a) Providing a rotor according to any of preceding aspect or embodiment, or a separator apparatus according to any preceding aspect or embodiment (43);
b) Continuously rotating the rotor (44);
c) Directing an effluent stream comprising gas and particles through the inlet of the rotor (45);
d) Conveying the effluent stream through the centrifugal separator such that at least some particles contact the surface and are biased towards the waste outlet (46); and
e) Venting gas through the gas outlet and directing at least some of the particles through the waste outlet (47).

The method may further comprise the step of recirculating water that has exited the rotor via the waste outlet (48). Advantageously, this may reduce water use by the apparatus.

The method may further comprise the step of mixing water with the effluent stream (49), prior to the step of the conveyance of the effluent stream through the centrifugal separator (46). The mixing step (49) may occur by the introduction of water to the effluent stream by a weir as described hereinbefore.

For the avoidance of doubt, features of any aspects or embodiments recited herein may be combined mutatis mutandis. It will be appreciated that various modifications may be made to the embodiments shown without departing from the spirit and scope of the invention as defined by the accompanying claims as interpreted under patent law.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A rotor for a separator apparatus, the rotor having an axis of rotation and comprising:
an inlet operable to receive an effluent stream,
an annular skirt defining a centrifugal separator operable to separate the effluent stream, the centrifugal separator having a gas outlet in a first direction and a waste outlet in a second direction, and
wherein a surface of the annular skirt is angled towards the axis of rotation of the rotor, such that during rotation of the rotor, non-gaseous matter in the effluent stream is biased towards the waste outlet by contact with said surface.

2. The rotor according to claim 1, wherein the gas outlet comprises one or more conduits extending within the annular skirt, and wherein a wall defining a conduit provides the surface, and/or wherein a generally radially inwardly facing wall of the annular skirt provides the surface, and/or wherein a generally radially outward facing wall of the annular skirt provides the surface.

3. The rotor according to claim 1, wherein the rotor comprises a generally cylindrical chamber defined by a base plate and an opposing roof plate coupled by the annular skirt.

4. The rotor according to claim 3, wherein the inlet is centrally located in the base plate or the opposing roof plate, preferably in the opposing roof plate.

5. The rotor according to claim 1, wherein the rotor comprises one or more radially extending vanes operable to convey the effluent stream from the inlet to the centrifugal separator.

6. The rotor according to claim 1, wherein at least a portion of the surface angled towards the axis of rotation is at an angle of from about 0.1° to about 45°, preferably from about 1° to about 20°, more preferably from about 5° to about 15°, for example 10°, to the axis of rotation.

7. The rotor according to claim 1, wherein a wall defining a conduit provides the surface and the conduit further comprises a first portion with walls that are substantially parallel to the axis of rotation of the rotor.

8. The rotor according to claim 3, wherein the annular skirt extends beyond the opposing roof plate in the first direction.

9. The rotor according to claim 3, wherein the gas outlet and waste outlet are in substantially opposite directions, preferably wherein the waste outlet comprises a plurality of ports within the annular skirt or base plate.

10. The rotor according to claim 1, wherein during operation, the components of the rotor remain substantially stationary relative to each other.

11. The rotor according to claim 1, wherein the inlet comprises a weir operable to introduce water into said effluent stream.

12. A separator apparatus comprising a rotor according to claim 1.

13. The separator apparatus according to claim 12, further comprising:
a stator defining a chamber that substantially surrounds the rotor,
a rotor shaft on which the rotor is arranged and configured to rotate relative to the stator,
a sump configured to collect non-gaseous matter from the waste port and/or from a clearance between the rotor and the stator,
an outlet port in the chamber configured to vent gas from the gas outlet, and
preferably, a liquid recirculation system operable to convey liquid from the sump to mix with the effluent stream.

14. A method of treating an effluent stream, comprising the steps of:
a. providing a rotor according to claim 1,
b. rotating the rotor,
c. directing an effluent stream comprising gas and particles through the inlet of the rotor,
d. conveying the effluent stream through the centrifugal separator such that at least some particles contact the surface and are biased towards the waste outlet,
e. venting gas through the gas outlet and directing at least some of the particles through the waste outlet.

15. The method of designing a rotor according to claim 1, comprising the steps of determining:
f. the angle and arrangement of the surface, and/or
g. the number of gas outlets, and/or
h. the number of waste outlets, and/or
i. the rotation speed of the rotor during operation, and/or
j. the number and arrangement of the vanes, and/or
k. the aspect ratio of the gas outlets,
required to separate at least some particles from the gas of the effluent stream.
